(19) United States
(12) Patent Application Publication
(10) Pub. No.: US 2025/0085531 A1
(43) Pub. Date: Mar. 13, 2025

(54) APPARATUS AND METHOD FOR MANUFACTURING OPTICAL DEVICE

(71) Applicant: Samsung Display Co., Ltd., Yongin-si (KR)

(72) Inventors: Bohyeon Hwang, Yongin-si (KR); Seongjin Yeon, Yongin-si (KR); Junho Park, Yongin-si (KR); Jaemin Lee, Yongin-si (KR)

(73) Assignee: Samsung Display Co., Ltd., Yongin-si (KR)

(21) Appl. No.: 18/830,962

(22) Filed: Sep. 11, 2024

(30) Foreign Application Priority Data
Sep. 13, 2023 (KR) 10-2023-0122042

(51) Int. Cl. G02B 27/00; G02B 7/00; G06F 30/20; G06N 7/01

(52) U.S. Cl. CPC G02B 27/0012; G02B 7/003; G06F 30/20; G06N 7/01

(57) ABSTRACT

An apparatus for manufacturing an optical device including a barrel portion and a first lens arranged in the barrel portion includes a light simulation part that receives initial design values for the optical device and simulate light passing through the optical device, and a Monte Carlo simulation part that determines whether the initial design values are appropriate by using Monte Carlo simulation.

### CROSS-REFERENCE TO RELATED APPLICATION(S)

This application claims priority to and benefits of Korean Patent Application No. 10-2023-0122042 under 35 U.S.C. § 119, filed on Sep. 13, 2023, in the Korean Intellectual Property Office (KIPO), the entire contents of which are incorporated herein by reference.

### BACKGROUND

### 1. Technical Field

The disclosure relates to an apparatus and method for manufacturing an optical device.

### 2. Description of the Related Art

Mobility-based electronic devices are widely used. As mobile electronic devices, tablet personal computers (PC) have been widely used in recent years, in addition to small electronic devices such as mobile phones.

A mobile electronic device includes a display device that provides visual information, such as an image or a video, to a user and supports various functions. Recently, as the size of other components for driving a display device has been reduced, the proportion of the display device in an electronic device has gradually increased, and a structure that may be bent by a certain angle from a flat state has been developed.

### SUMMARY

Embodiments include an apparatus for manufacturing an optical device that predicts a performance trend of the optical device by using Monte Carlo simulation without actually manufacturing the optical device.

However, the objectives and the scope of the disclosure are not limited thereto.

Additional aspects will be set forth in part in the description which follows and, in part, will be apparent from the description, or may be learned by practice of the embodiments of the disclosure.

According to an embodiment, an apparatus for manufacturing an optical device including a barrel portion and a first lens arranged in the barrel portion includes a light simulation part that receives initial design values for the optical device and simulate light passing through the optical device, and a Monte Carlo simulation part that determines whether the initial design values are appropriate by using Monte Carlo simulation.

In an embodiment, the light simulation part may include an initial value input part that receives a first-first value, which is an initial standard dimension, and a first-second value, which is an initial tolerance value, for each of a plurality of first variables that are design variables of the optical device, and an ideal light value extraction part that extracts an ideal second-first value of a second variable for light passing through the optical device, that is expected to be obtained when manufacturing the optical device with the first-first value and the first-second value for each of the plurality of first variables. The Monte Carlo simulation part may include a random value extraction part that randomly extracts a first-31 value and a first-32 value for each of the plurality of first variables, each of the first-31 value and the first-32 value having an absolute value that is less than an absolute value of the first-second value, a first case extraction part that extracts, for each of the plurality of first variables, a second-21 value of the second variable, which is expected to be obtained when manufacturing the optical device in a first case where a standard dimension is the first-first value, and a design error is the first-31 value, a second case extraction part that extracts, for each of the plurality of first variables, a second-22 value of the second variable, which is expected to be obtained when manufacturing the optical device in a second case where the standard dimension is the first-first value, and the design error is the first-32 value, a case selection part that selects one of the first case and the second case by determining a value closer to the ideal second-first value from among the second-21 value and the second-22 value, a spot size extraction part that extracts a spot size of light that has passed through the optical device for the one of the first case and the second case selected by the case selection part, a uniformity calculation part that calculates a uniformity of spot sizes of light that has passed through the optical device, and a determination part that determines whether the first-first value and the first-second value are appropriate, based on the uniformity calculated by the uniformity calculation part.

In an embodiment, the spot size extraction part may extract the spot size of light that has passed through the optical device in a first direction and the spot size of light that has passed through the optical device in a second direction intersecting the first direction, and the uniformity calculation part may include a first value calculation part that calculates a first size value that is a greater value of a maximum value of the spot size in the first direction and a maximum value of the spot size in the second direction, a second size calculation part that calculates a second size value that is a smaller value of a minimum value of the spot size in the first direction and a minimum value of the spot size in the second direction, and a deviation calculation part that calculates a deviation of each of the first size value and the second size value.

In an embodiment, the determination part may further determine that the first-first value and the first-second value are appropriate in case that the deviation is in a range of 0 to a specified value.

In an embodiment, the plurality of first variables may include at least one of a curvature of the first lens, a central thickness of the first lens, and a diameter of the first lens.

In an embodiment, the plurality of first variables may include at least one of an angle at which the first lens is tilted from the barrel portion, a distance from a central axis of the barrel portion to a center of the first lens, a distance from an opening portion of the barrel portion to the first lens, and a diameter of the opening portion of the barrel portion.

In an embodiment, the second variable may include a spot root-mean-square (RMS) radius.

In an embodiment, the second variable may include a root-mean-square (RMS) wavefront aberration value.

According to an embodiment, a method of manufacturing an optical device including a barrel portion and a first lens arranged in the barrel portion may include a light simulation operation of receiving initial design values for the optical device and simulating light passing through the optical device, and a Monte Carlo simulation operation of determining whether the initial design values are appropriate by using Monte Carlo simulation.

In an embodiment, the light simulation operation may include an initial value inputting operation of receiving a first-first value, which is an initial standard dimension, and a first-second value, which is an initial tolerance value, for each of a plurality of first variables that are design variables of the optical device, and an ideal light value extracting operation of extracting an ideal second-first value of a second variable for light passing through the optical device, that is expected to be obtained when manufacturing the optical device with the first-first value and the first-second value for each of the plurality of first variables. The Monte Carlo simulation operation may include a random value extracting operation of randomly extracting a first-31 value and a first-32 value for each of the plurality of first variables, each of the first-31 value and the first-32 value having an absolute value that is less than an absolute value of the first-second value, a first case extracting operation of extracting, for each of the plurality of first variables, a second-21 value of the second variable, which is expected to be obtained when manufacturing the optical device in a first case where a standard dimension is the first-first value, and a design error is the first-31 value, a second case extracting operation of extracting, for each of the plurality of first variables, a second-22 value of the second variable, which is expected to be obtained when manufacturing the optical device in a second case where the standard dimension is the first-first value, and the design error is the first-32 value, a case selecting operation of selecting one of the first case and the second case by determining a value closer to the ideal second-first value from among the second-21 value and the second-22 value, a spot size extracting operation of extracting a spot size of light that has passed through the optical device for the one of the first case and the second case selected in the case selecting operation, a uniformity calculating operation of calculating a uniformity of spot sizes of light that has passed through the optical device, and a determination operation of determining whether the first-first value and the first-second value are appropriate, based on the uniformity calculated in the uniformity calculating operation.

In an embodiment, the spot size extracting operation may include extracting the spot size of light that has passed through the optical device in a first direction and the spot size of light that has passed through the optical device in a second direction intersecting the second direction, and the uniformity calculating operation may include a first size value calculating operation of calculating a first size value that is a greater value of a maximum value of the spot size in the first direction and a maximum value of the spot size in the second direction, a second size value calculating operation of calculating a second size value that is a smaller value of a minimum value of the spot size in the first direction and a minimum value of the spot size in the second direction, and a deviation calculating operation of calculating a deviation of each of the first size value and the second size value.

In an embodiment, the determination operation may include determining that the first-first value and the first-second value are appropriate in case that the deviation is in a range of 0 to a specified value.

In an embodiment, the plurality of first variables may include at least one of a curvature of the first lens, a central thickness of the first lens, and a diameter of the first lens.

In an embodiment, the plurality of first variables may include at least one of an angle at which the first lens is tilted from the barrel portion, a distance from a central axis of the barrel portion to a center of the first lens, a distance from an opening portion of the barrel portion to the first lens, and a diameter of the opening portion of the barrel portion.

In an embodiment, the second variable may include a spot RMS radius.

In an embodiment, the second variable may include a RMS wavefront aberration value.

Other aspects, features, and advantages other than those described above will now become apparent from the following drawings, claims, and the detailed description of the disclosure.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a schematic block diagram of an optical system according to an embodiment;

FIG. 2 is a schematic cross-sectional view of an optical device according to an embodiment;

FIG. 3 is a plan view of a display substrate irradiated with light, according to an embodiment;

FIG. 4 is a graph showing a spot intensity of light according to an embodiment;

FIG. 5 is a schematic block diagram of an apparatus for manufacturing an optical device according to an embodiment;

FIG. 6 is a schematic block diagram of a light simulation unit according to an embodiment;

FIG. 7 is a schematic block diagram of a Monte Carlo simulation unit according to an embodiment;

FIG. 8 is a schematic flowchart illustrating a method of manufacturing an optical device according to an embodiment;

FIG. 9 is a schematic plan view of a display device according to an embodiment;

FIG. 10 is a schematic cross-sectional view of a display device according to an embodiment; and

FIG. 11 is schematic diagram of an equivalent circuit of a pixel of a display panel according to an embodiment.

### DETAILED DESCRIPTION OF THE EMBODIMENTS

Reference will now be made in detail to embodiments, of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description. In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

As the disclosure allows for various changes and numerous embodiments, particular embodiments will be illustrated in the drawings and described in detail in the written description. Effects and features of the disclosure and methods of achieving the same will be apparent with reference to embodiments and drawings described below in detail. The disclosure may, however, be embodied in many different forms and should not be construed as being limited to the embodiments set forth herein.

The disclosure will now be described more fully with reference to the accompanying drawings, in which embodiments of the disclosure are shown. Like reference numerals in the drawings denote like elements, and thus their description will not be repeated.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Sizes of elements in the drawings may be exaggerated for convenience of explanation. In other words, since sizes and thicknesses of components in the drawings are arbitrarily illustrated for convenience of explanation, the following embodiments are not limited thereto.

The x-axis, the y-axis, and the z-axis are not limited to three axes on the orthogonal coordinates system, and may be interpreted in a broad sense including the same. For example, the x-axis, the y-axis, and the z-axis may be perpendicular to one another, or may represent different directions that are not perpendicular to one another.

When a certain embodiment may be implemented differently, a specific process order may be performed differently from the described order. For example, two consecutively described processes may be performed substantially at the same time or performed in an order opposite to the described order.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

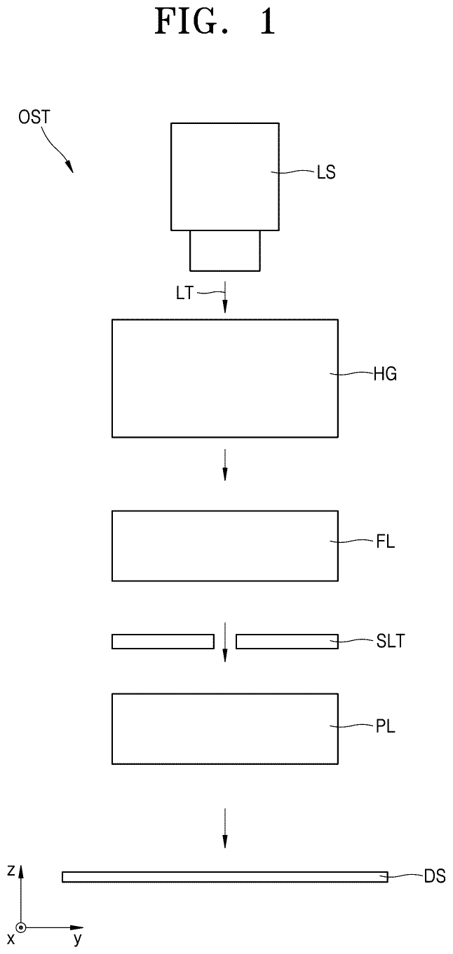

FIG. 1 is a schematic block diagram of an optical system OST according to an embodiment.

Referring to FIG. 1, the optical system OST may include a light source LS, a homogenizer HG, a field lens unit FL, a slit SLT, and a projection lens unit PL.

The light source LS may emit light LT. For example, an excimer laser beam may be emitted. The light source LS may include a resonator. Generally, most of the light LT emitted spontaneously or stimulated from a medium may have no particular direction and spreads out in all directions. Accordingly, to oscillate the light LT, it may be desirable to return the spreading light LT into the medium and stimulate atoms or molecules that are still in an excited state to continue generating stimulated emission. To this end, mirrors may be arranged on sides to continuously return the light LT, which is called a laser resonator. The light LT may be a light LT in a resonance state coming out from the laser resonator by a little amount through one mirror that partially transmits the light LT.

The homogenizer HG may be positioned in a path of the light LT emitted from the light source LS. The homogenizer HG may serve to equalize the intensity of light LT in a two-dimensional space. For example, the intensity distribution of a laser beam may be made uniform in the two-dimensional space that is a cross section of the light LT incident on the homogenizer HG. To this end, the optical system OST may also be provided with two homogenizers HG.

The homogenizer HG may have a fly-eye lens to separate an incident laser beam into multiple laser beams. The laser beams may pass through a lens such as a convex lens and the field lens unit FL, and the light LT may be irradiated onto a display substrate. Through this process, the intensity distribution of the laser beam may be made uniform in the two-dimensional space that is the cross section of the light LT incident on the homogenizer HG. This means that the laser beam incident on an amorphous silicon layer on the display substrate may have a uniform intensity distribution within a laser-irradiated area of the amorphous silicon layer. Accordingly, a polysilicon layer formed after crystallization of the amorphous silicon layer may have uniform characteristics at various points. For example, the optical system OST may create polysilicon having uniform characteristics by crystallizing the amorphous silicon layer on the display substrate.

A laser beam that has passed through the field lens unit FL may sequentially pass through the slit SLT and the projection lens unit PL. FIG. 1 schematically shows one field lens unit FL, but the disclosure is not limited thereto, and in another embodiment, the field lens unit FL may include multiple lenses, such as a convex lens and/or a concave lens. The projection lens unit PL may be positioned on the path of the light LT that has passed through the homogenizer HG. The projection lens unit PL may include one lens or may include multiple lenses. For example, the projection lens unit PL may include a convex lens, a convex lens with one flat side, and/or a concave lens or the like.

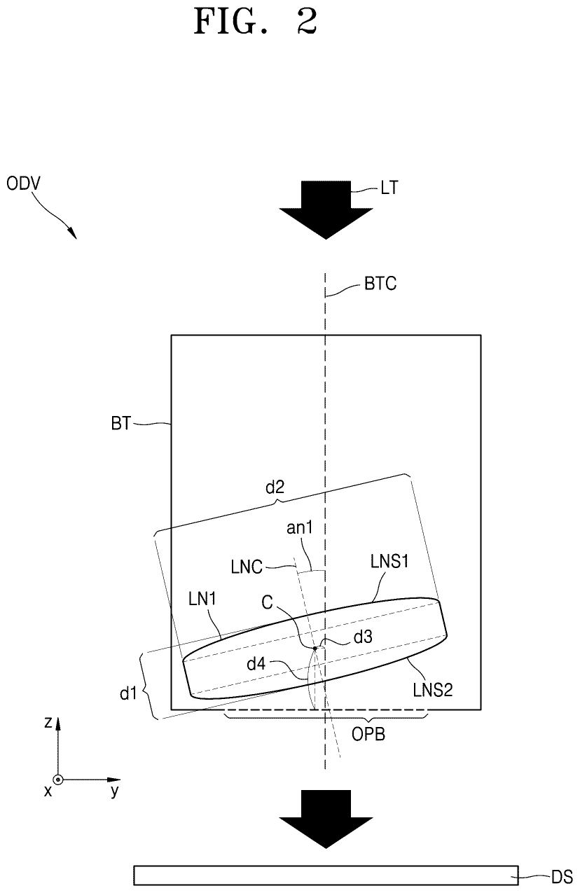

FIG. 2 is a schematic cross-sectional view of an optical device ODV according to an embodiment.

Referring to FIG. 2, the optical device ODV may include a barrel portion BT and a first lens LN1.

The optical device ODV may be at least one of the light source LS, the homogenizer HG, the field lens unit FL, the slit SLT, and the projection lens unit PL, which are described above with reference to FIG. 1.

The barrel portion BT may form an exterior of the optical device ODV. The barrel portion BT may provide an inner space for the first lens LN1 arranged in the barrel portion BT. The barrel portion BT may protect the first lens LN1 from external impact. Also, the barrel portion BT may reduce contamination of the first lens LN1 by an external foreign material. The barrel portion BT may be provided in a symmetrical shape with respect to a central axis BTC. For example, the barrel portion BT may be provided in a cylindrical shape. However, the shape of the barrel portion BT is not limited thereto.

A side of the barrel portion BT may have an opening portion OPB. Accordingly, the light LT may pass through the opening portion OPB of the barrel portion BT. A shape of the opening portion OPB may correspond to the shape of the first lens LN1. For example, a planar shape of the opening portion OPB may be circular. FIG. 2 shows that one opening portion OPB is disposed on a lower surface of the barrel portion BT, but the disclosure is not limited thereto, and multiple opening portions OPB may be provided and arranged in various positions of the barrel portion BT.

The first lens LN1 may be arranged in the inner space of the barrel portion BT. The first lens LN1 may be fixed to the barrel portion BT to overlap the opening portion OPB of the barrel portion BT in a plan view. The first lens LN1 may be provided in a symmetrical shape with respect to a central axis LNC. The first lens LN1 may include a first surface LNS1 and a second surface LNS2. The first surface LNS1 and the second surface LNS2 may form opposite surfaces of the first lens LN1. The light LT may be incident on the first surface LNS1, emitted from the second surface LNS2, and pass through the opening portion OPB of the barrel portion BT.

For example, each of the first surface LNS1 and the second surface LNS2 may be a curved surface. For example, each of the first surface LNS1 and the second surface LNS2 may be a convex surface. For example, the first lens LN1 may be a convex lens. However, the type of the first lens LN1 is not limited thereto. For example, at least one of the first surface LNS1 and the second surface LNS2 may be a flat surface, or at least one of the first surface LNS1 and the second surface LNS2 may be a concave surface.

FIG. 2 shows only the barrel portion BT and the first lens LN1, but the disclosure is not limited thereto, and the optical device ODV may further include various types of lens, mirrors, and electronic devices.

In designing the optical device ODV, multiple design variables may be considered. A design variable of the optical device ODV may be referred to as a first variable.

For example, the first variable may include a curvature of the first lens LN1. The curvature of the first lens LN1 may be a curvature of the first surface LNS1 and the second surface LNS2. The first variable may include a central thickness d1 of the first lens LN1. The central thickness d1 of the first lens LN1 may be a distance between two points where the central axis LNC, the first surface LNS1, and the second surface LNS2 of the first lens LN1 meet. The first variable may be a diameter d2 of the first lens LN1. A planar shape of the first lens LN1 may be circular, and the diameter d2 of the first lens LN1 may be a diameter of the planar shape of the first lens LN1.

The first variable may include an angle an1 at which the first lens LN1 is tilted from the barrel portion BT. The angle an1 at which the first lens LN1 is tilted from the barrel portion BT may be an angle between the central axis BTC of the barrel portion BT and the central axis LNC of the first lens LN1. The first variable may include a distance d3 from the central axis BTC of the barrel portion BT to a center C of the first lens LN1. The first variable may include a distance d4 from the opening portion OPB of the barrel portion BT to the center C of the first lens LN1. The first variable may include a diameter of the opening portion OPB of the barrel portion BT.

In other words, the first variable may include at least one of the curvature of the first lens LN1, the central thickness d1 of the first lens LN1, the diameter d2 of the first lens LN1, the angle an1 at which the first lens LN1 is tilted from the barrel portion BT, the distance d3 from the central axis BTC of the barrel portion BT to the center C of the first lens LN1, the distance d4 from the opening portion OPB of the barrel portion BT to the center C of the first lens LN1, and the diameter of the opening portion OPB of the barrel portion BT. In designing the optical device ODV multiple first variables may be considered.

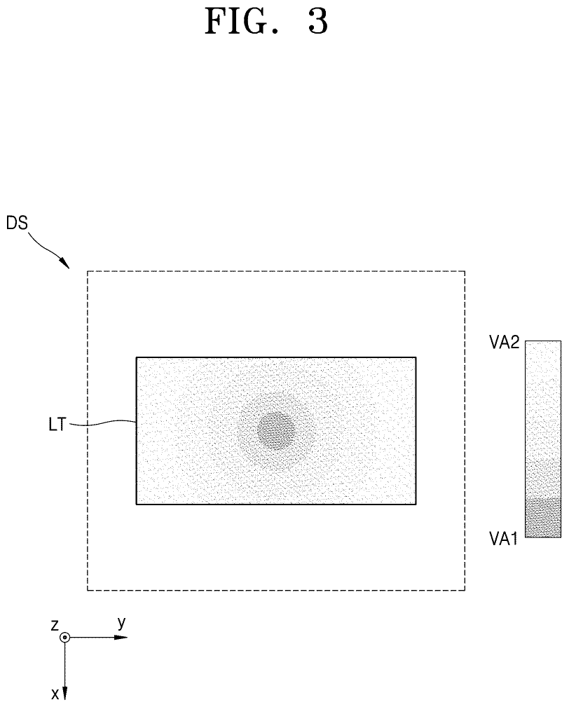

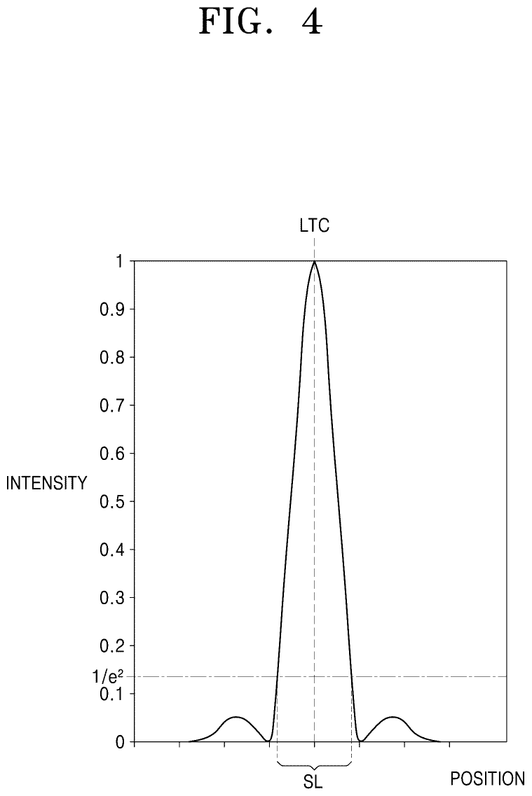

FIG. 3 is a plan view of a display substrate DS irradiated with light LT, according to an embodiment, and FIG. 4 is a graph showing a spot intensity of the light LT according to an embodiment.

Referring to FIGS. 2 to 4, the light LT that has passed through the optical device ODV may be irradiated to the display substrate DS.

As shown in FIG. 3, the light LT irradiated on the display substrate DS may form a beam shape. FIG. 3 shows that a shape of the light LT irradiated on the display substrate DS is rectangular in a plan view, but the shape of the light LT is not limited thereto.

FIG. 4 is a graph showing a spot intensity of the light LT at a position on the display substrate DS. The horizontal axis represents a position, and the vertical axis represents an intensity of the light LT. In particular, the vertical axis shows a relative value where a maximum value of the intensity of the light LT is set to 1. The horizontal axis may be a position in a first direction (e.g., an x axis direction) or a position in a second direction (e.g., a y axis direction). The first direction (e.g., the x axis direction) and the second direction (e.g., the y axis direction) may be directions intersecting each other.

The intensity of the light LT may be symmetrical with respect to a light axis LTC. The intensity of the light LT may be the highest at the light axis LTC, and the intensity of the light LT may decrease as a distance from the light axis LTC increases. FIG. 4 illustrates two points where the intensity of the light LT reaches a value of 1/e², and a distance SL between the two points is referred to as a light spot size.

Referring to FIG. 3 again, shading is displayed according to a light spot size. FIG. 3 illustrates that the light spot size varies according to a position of the display substrate DS wherein the light LT is irradiated. In particular, FIG. 3 illustrates that the light spot size is small at a central portion, and the light spot size increases as a distance from the central portion increases. The smallest value among light spot sizes is referred to as a first value VA1, and the largest value among the light spot sizes is referred to as a second value VA2.

A spot size uniformity of the light LT may be calculated from a deviation between the first value VA1 and the second value VA2. For example, the spot size uniformity of light LT may improve as the deviation between the first value VA1 and the second value VA2 decreases, and the spot size uniformity of light LT may be reduced as the deviation between the first value VA1 and the second value VA2 increases.

Table 1 below shows an example of calculation of a spot size according to an embodiment.

TABLE 1

| | Spot size in | Spot size in |
|---|---|---|
| | first direction | second direction |
| second value VA2 | 8.06 μm | 8.12 μm |
| first value VA1 | 7.53 μm | 8.01 μm |

In an embodiment, as shown in Table 1, the spot size may be analyzed as a spot size in the first direction (e.g., the x axis direction) and a spot size in the second direction (e.g., the y axis direction).

The spot size uniformity may be calculated by a deviation (8.12 μm-7.53 μm=0.59 μm) between a first size value (8.12 μm), which is a greater value between the second value VA2 (8.06 μm) in the first direction (e.g., the x axis direction) and the second value VA2 (8.12 μm) in the second direction (e.g., the y axis direction), and a second size value (7.53 μm), which is a smaller value between the first value VA1 in the first direction (e.g., the x axis direction) and the first value VA1 in the second direction (e.g., the y axis direction).

Table 2 below shows an example of calculation of a spot size according to an embodiment.

TABLE 2

| | | Spot size in | Spot size in |
|---|---|---|---|
| | | first direction | second direction |
| FOCUS | second value VA2 | 8.06 μm | 8.12 μm |
| | first value VA1 | 7.53 μm | 8.01 μm |
| depth of | second value VA2 | 8.18 μm | 8.38 μm |
| field (DOF) | first value VA1 | 7.48 μm | 8.06 μm |
| upper limit | | | |
| DOF lower | second value VA2 | 8.22 μm | 8.22 μm |
| limit | first value VA1 | 7.77 μm | 7.93 μm |

A positional relationship between the optical device ODV and the display substrate DS may be variously adjusted.

FOCUS refers to a case where the positional relationship between the optical device ODV and the display substrate DS is set so that the light LT that has passed through the optical device ODV is accurately focused on the display substrate DS.

DOF refers to a depth of field. The DOF upper limit refers to a case where the positional relationship between the optical device ODV and the display substrate DS is set just before the light LT irradiated on the display substrate DS becomes blurred in case that the optical device ODV and the display substrate DS are arranged to be gradually further apart. The DOF lower limit refers to a case where the positional relationship between the optical device ODV and the display substrate DS is set just before the light LT irradiated on the display substrate DS becomes blurred in case that the optical device ODV and the display substrate DS are arranged to be gradually closer to each other.

Table 2 above may be organized as Table 3 below.

TABLE 3

| | |
|---|---|
| Maximum value | 8.38 μm |
| Minimum value | 7.48 μm |
| Deviation | 8.38-7.48 = 0.9 μm |

The maximum value may refer to the largest value among the second values VA2 of the FOCUS, the DOF upper limit, and the DOP lower limit, the minimum value may refer to the smallest value among the first values VA1 of the FOCUS, the DOF upper limit, and the DOF lower limit, and the deviation may refer to a difference between the maximum value and the minimum value. The spot size uniformity may be improved as the deviation decreases.

Embodiments of the disclosure aim to set respective numerical values of multiple first variables so that the light size uniformity is maintained at a certain quality or higher.

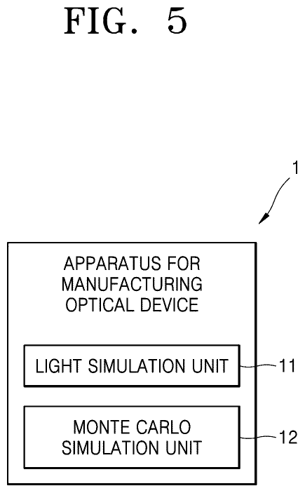

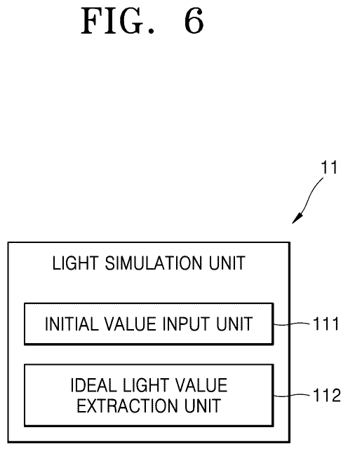

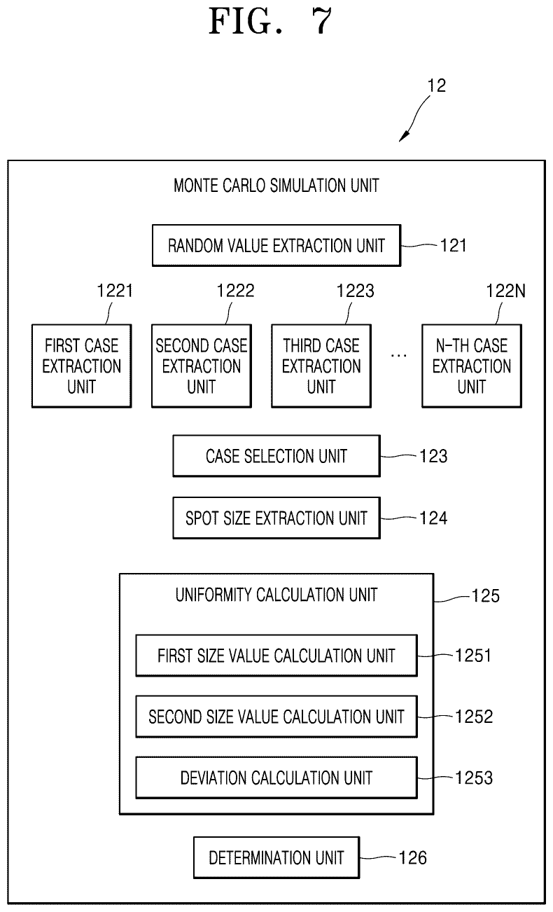

FIG. 5 is a schematic block diagram of an apparatus 1 for manufacturing an optical device according to an embodiment, FIG. 6 is a schematic block diagram of a light simulation unit 11 according to an embodiment, and FIG. 7 is a schematic block diagram of a Monte Carlo simulation unit 12 according to an embodiment.

Referring to FIGS. 2 to 7, the apparatus 1 for manufacturing an optical device may include a light simulation unit 11 and a Monte Carlo simulation unit 12.

The light simulation unit 11 may receive an initial design value for the optical device ODV and simulate light LT passing through the optical device ODV. For example, the light simulation unit 11 may receive a value of each of multiple first variables to simulate at least one of an ideal spot root-mean-square (RMS) radius and an RMS wavefront aberration value. The light simulation unit 11 may include an initial value input unit 111 and an ideal light value extraction unit 112.

The initial value input unit 111 may receive a first-1 (first-first value, which is an initial standard dimension, and a first-2 (first-second) value, which is an initial tolerance value, for each of the first variables.

The first variables may be various as described above with reference to FIG. 2, but for convenience of explanation, an embodiment where the first variables include two variables, which are the central thickness d1 of the first lens LN1 and the diameter d2 of the first lens LN1, is described.

Table 4 shows examples of the first-1 value and the first-2 value, which are input to the initial value input unit 111.

TABLE 4

| First variables | | |
|---|---|---|
| | Central thickness d1 | Diameter d2 of the |
| | of the first lens LN1 | first lens LN1 |

| | | | | |
|---|---|---|---|---|
| First-1 value | 10 | mm | 100 | mm |
| First-2 value | ±0.5 | mm | ±3 | mm |

For example, the initial value input unit 111 may receive the variables where the first-1 value and the first-2 value of the central thickness d1 of the first lens LN1 are respectively 10 mm and ±0.5 mm from among the first variables. Also, the initial value input unit 111 may receive the variables where the first-1 value and the first-2 value of the diameter d2 of the first lens LN1 are respectively 100 mm and ±3 mm from among the first variables.

The ideal light value extraction unit 112 may extract an ideal second-1 (second-first) value of a second variable for light LT passing through the optical device ODV, that is expected to be obtained when manufacturing the optical device ODV with the first-1 value and the first-2 value for each of the first variables. For example, the second variable may be a spot RMS radius.

For example, the ideal light value extraction unit 112 may simulate the spot RMS radius of the light LT irradiated on a display substrate, that is expected to be obtained when manufacturing the optical device ODV with the first-1 value and the first-2 value, which are listed in Table 4.

Table 5 shows a second-1 value of a second variable, which is expected to be obtained when manufacturing the optical device ODV with the values listed in Table 4. Here, the second-1 value is the spot RMS radius of the light LT irradiated on the display substrate.

TABLE 5

| | |
|---|---|
| Nominal spot RMS radius | 0.00022664 m |
| Estimated change | 0.00096268 m |
| Second-1 value | 0.00118931 m |

The nominal spot RMS radius is an expected spot RMS radius value of the light LT in case that the central thickness d1 of the first lens LN1 and the diameter d2 of the first lens LN1 are each manufactured according to a standard dimension of the first-1 value without error. The estimated change is a spot RMS radius change value of the ideal light LT in case that a tolerance value is the first-2 value. The second-1 value is a value obtained by adding the estimated change to the nominal spot RMS radius.

The second-1 value is only a theoretically calculated ideal value, and in reality, when manufacturing the optical device ODV, the spot RMS radius of the light LT may be varied and may not be exactly the second-1 value.

The Monte Carlo simulation unit 12 may determine whether initial design values (e.g., the first-1 value and the first-2 value) are appropriate by using Monte Carlo simulation. A time and cost may be wasted for actually manufacturing the optical device ODV and evaluating the performance of the optical device ODV.

The Monte Carlo simulation unit 12 may predict a performance trend, which is expected to be obtained when manufacturing the optical device ODV within a tolerance value, by using Monte Carlo simulation, without actually manufacturing the optical device ODV. The Monte Carlo simulation unit 12 may determine whether the initial design values (e.g., the first-1 value and the first-2 value) are appropriate. The performance of the optical device ODV may be a uniformity of light spot size.

The Monte Carlo simulation unit 12 may include a random value extraction unit 121, a first case extraction unit 1221, a second case extraction unit 1222, a third case extraction unit 1223, . . . , and an N-th case extraction unit 122N, a case selection unit 123, a spot size extraction unit 124, a uniformity calculation unit 125, and a determination unit 126.

The random value extraction unit 121 may randomly extract a first-31 value, a first-32 value, a first-33 value, . . . , and a first-3N value, each of which has an absolute value that is less than an absolute value of the first-2 value, for each of the first variables.

Table 6 shows the first-31 value, the first-32 value, the first-33 value, . . . , and the first-3N value, which are extracted by the random value extraction unit 121.

TABLE 6

First variables

| | Central thickness d1 | Diameter d2 of the |
|---|---|---|
| | of the first lens LN1 | first lens LN1 |
| First-2 value | ±0.5 mm | ±3 mm |
| First-31 value | 0.3 | 2 |
| First-32 value | −0.2 | −1 |
| First-33 value | −0.4 | −2.5 |
| . . . | . . . | . . . |
| First-3N value | 0.1 | 1 |

Because an absolute value of each of the first-31 value, the first-32 value, the first-33 value, . . . , and the first-3N value is less than the first-2 value, which is a tolerance value, when actually manufacturing by setting the first-2 value as the tolerance value, errors of the first-31 value, the first-32 value, the first-33 value, . . . , and the first-3N value may appear.

The first case extraction unit 1221 may extract, for each of the first variables, a second-21 value of a second variable, which is expected to be obtained when manufacturing the optical device ODV in a first case where the standard dimension is the first-1 value, and a design error is the first-31 value.

The second case extraction unit 1222 may extract, for each of the first variables, a second-22 value of the second variable, which is expected to be obtained when manufacturing the optical device ODV in a second case where the standard dimension is the first-1 value, and the design error is the first-32 value.

The third case extraction unit 1223 may extract, for each of the first variables, a second-23 value of the second variable, which is expected to be obtained when manufacturing the optical device ODV in a third case where the standard dimension is the first-1 value, and the design error is the first-33 value.

The N-th case extraction unit 122N may extract, for each of the first variables, a second-2N value of the second variable, which is expected to be obtained when manufacturing the optical device ODV in an N-th case where the standard dimension is the first-1 value, and the design error is the first-3N value.

As described above, the second variable may be the spot RMS radius.

Table 7 shows examples of values extracted by the first case extraction unit 1221, the second case extraction unit 1222, the third case extraction unit 1223, . . . , and the N-th case extraction unit 122N.

TABLE 7

| | First variables | | |
|---|---|---|---|
| | Central thickness d1 of | Diameter d2 of the | Second variable |
| | the first lens LN1 | first lens LN1 | Spot RMS radius |
| First case | 10 mm + 0.3 mm = 10.3 mm | 100 mm + 2 mm = 102 mm | 0.00102341 m |
| Second case | 10 mm − 0.2 mm = 9.8 mm | 100 mm − 1 mm = 99 mm | 0.00923421 m |
| Third case | 10 mm − 0.4 mm = 9.6 mm | 100 mm − 2.5 mm = 97.5 | 0.00913423 m |
| . . . | . . . | . . . | . . . |
| N-th case | 10 mm + 0.1 mm = 10.1 mm | 100 mm + 1 mm = 101 mm | 0.00812342 m |

The first case extraction unit 1221 may extract 0.00102341m (the second-21 value), which is the spot RMS radius expected when manufacturing the optical device ODV in the first case where the standard dimension of the central thickness d1 of the first lens LN1 is 10 mm (the first-1 value) and the design error is 0.3 mm (the first-31 value), and the standard dimension of the diameter d2 of the first lens LN1 is 100 mm (the first-1 value) and the design error is 2 mm (the first-31 value).

The second case extraction unit 1222 may extract 0.00923421m (the second-22 value), which is the spot RMS radius expected when manufacturing the optical device ODV in the second case where the standard dimension of the central thickness d1 of the first lens LN1 is 10 mm (the first-1 value) and the design error is-0.2 mm (the first-32 value), and the standard dimension of the diameter d2 of the first lens LN1 is 100 mm (the first-1 value) and the design error is-1 mm (the first-32 value).

The third case extraction unit 1223 may extract 0.00913423m (the second-23 value), which is the spot RMS radius expected when manufacturing the optical device ODV in the third case where the standard dimension of the central thickness d1 of the first lens LN1 is 10 mm (the first-1 value) and the design error is-0.4 mm (the first-33 value), and the standard dimension of the diameter d2 of the first lens LN1 is 100 mm (the first-1 value) and the design error is-2.5 mm (the first-33 value).

The N-th case extraction unit 122N may extract 0.00812342m (the second-2N value), which is the spot RMS radius expected when manufacturing the optical device ODV in the N-th case where the standard dimension of the central thickness d1 of the first lens LN1 is 10 mm (the first-1 value) and the design error is-0.1 mm (the first-3N value), and the standard dimension of the diameter d2 of the first lens LN1 is 100 mm (the first-1 value) and the design error is 1 mm (the first-3N value).

The case selection unit 123 may select one of the first case, the second case, the third case, . . . , and the N-th case by determining a value close to the second-1 value from among the second-21 value, the second-22 value, the second-23 value, . . . , and the second-2N value.

For example, in case that the results shown in Tables 4 to 7 are derived, the second-1 value, the second-21 value, the second-22 value, the second-23 value, . . . , and the second-2N value may be summarized as in Table 8.

TABLE 8

| | |
|---|---|
| Second-1 value | 0.00118931 m |
| Second-21 value (first case) | 0.00102341 m |
| Second-22 value (second case) | 0.00923421 m |
| Second-23 value (third case) | 0.00913423 m |
| . . . | . . . |
| Second-2N value (N-th case) | 0.00812342 m |

The case selection unit 123 may select the first case because the second-21 value is closest to the second-1 value.

The spot size extraction unit 124 may extract a spot size of the light LT that has passed through the optical device ODV for the case selected by the case selection unit 123.

In Table 8, because the first case was selected, in case that the central thickness d1 of the first lens LN1 is manufactured to 10.3 mm, and the diameter d2 of the first lens LN1 was manufactured to 102 mm, as shown in Table 7, the spot size of the light LT that has passed through the optical device ODV may be extracted. The spot size extraction unit 124 may extract a spot size of the light LT that has passed through the optical device ODV in a first direction (e.g., an x axis direction) and a spot size of the light LT that has passed through the optical device ODV in a second direction (e.g., a y axis direction).

The uniformity calculation unit 125 may calculate the uniformity of the spot sizes extracted by the spot size extraction unit 124. The uniformity calculation unit 125 may include a first size value calculation unit 1251 calculating a first size value, a second size value calculation unit 1252 calculating a second size value, and a deviation calculation unit 1253 calculating a deviation of each of the first size value and the second size value. A method of extracting spot sizes and calculating the uniformity of the spot sizes has been described above with reference to FIG. 3, and thus detailed description thereof is omitted.

The determination unit 126 may determine whether the first-1 value and the first-2 value are appropriate, based on the uniformity extracted by the uniformity calculation unit 125. In case that the deviation calculated by the deviation calculation unit 1253 is between 0 and a specified value, the determination unit 126 may determine that the first-1 value and the first-2 value are appropriate.

On the contrary, in case that the deviation calculated by the deviation calculation unit 1253 is greater than the specified value, the determination unit 126 may determine that at least one of the first-1 value and the first-2 value is not appropriate, and at least one of the first-1 value and the first-2 value may be redesigned.

Description was made based on an embodiment that the second variable is the spot RMS radius, but a type of the second variable is not limited thereto. The description may be applied the same even in case that the second variable is an RMS wavefront aberration value.

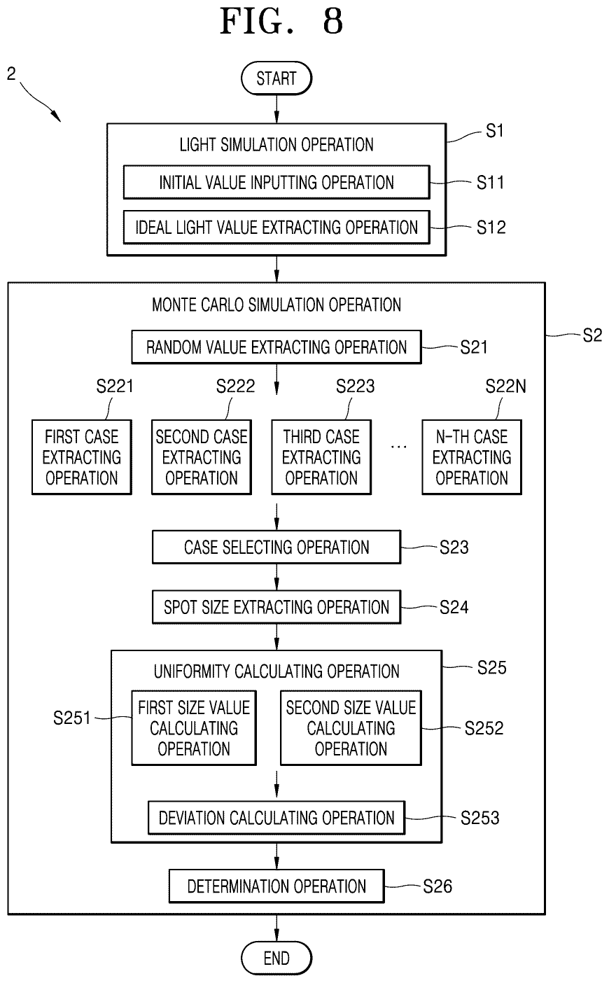

FIG. 8 is a schematic flowchart illustrating a method 2 of manufacturing an optical device according to an embodiment.

In FIG. 8, the same reference numerals as those in FIGS. 1 to 7 refer to the same members, and redundant descriptions thereof are omitted.

The method 2 of manufacturing the optical device may include light simulation operation S1 and Monte Carlo simulation operation S2.

Light simulation operation S1 may be an operation of receiving initial design values for an optical device and simulating light passing through the optical device. Light simulation operation S1 may include initial value inputting operation S11 and ideal light value extracting operation S12.

Initial value inputting operation S11 may be an operation of receiving a first-1 value, which is an initial standard dimension, and a first-2 value, which is an initial tolerance value, for each of multiple first variables that are design variables of the optical device.

Ideal light value extracting operation S12 may be an operation of extracting an ideal second-1 value of a second variable for light passing through the optical device, that is expected to be obtained when manufacturing the optical device with the first-1 value and the first-2 value for each of the first variables.

Monte Carlo simulation operation S2 may be an operation of determining whether the initial design values are appropriate by using Monte Carlo simulation. Monte Carlo simulation operation S2 may include random value extracting operation S21, first case extracting operation S221, second case extracting operation S222, third case extracting operation S223, . . . , and N-th case extracting operation S22N, case selecting operation S23, spot size extracting operation S24, uniformity calculating operation S25, and determination operation S26.

Random value extracting operation S21 may be an operation of randomly extracting a first-31 value, a first-32 value, a first-33 value, . . . , and a first-3N value, which are less than an absolute value of the first-2 value, for each of the first variables.

First case extracting operation S221 may be an operation of extracting, for each of the first variables, a second-21 value of a second variable, which is expected to be obtained when manufacturing the optical device in a first case where the standard dimension is the first-1 value, and a design error is the first-31 value.

Second case extracting operation S222 may be an operation of extracting, for each of the second variables, a second-22 value of the second variable, which is expected to be obtained when manufacturing the optical device in a second case where the standard dimension is the first-1 value, and the design error is the first-32 value.

Third case extracting operation S223 may be an operation of extracting, for each of the first variables, a second-23 value of the second variable, which is expected to be obtained when manufacturing the optical device in a third case where the standard dimension is the first-1 value, and the design error is the first-33 value.

N-th case extracting operation S22N may be an operation of extracting, for each of the first variables, a second-2N value of the second variable, which is expected to be obtained when manufacturing the optical device in an N-th case where the standard dimension is the first-1 value, and the design error is the first-3N value.

Case selecting operation S23 may be an operation of selecting any one of the first case, the second case, the third case, . . . , and the N-th case by determining a value close to the second-1 value from among the second-21 value, the second-22 value, the second-23 value, . . . , and the second-2N value.

Spot size extracting operation S24 may be an operation of extracting a spot size of light that has passed through the optical device for any one case selected by a case selection unit. Operation S24 of selecting the spot size may be an operation of extracting a spot size of the light that has passed through the optical device in a first direction (e.g., an x axis direction) and a spot size of the light that has passed through the optical device in a second direction (e.g., a y axis direction).

Uniformity calculating operation S25 may be an operation of calculating the uniformity of spot sizes of light that has passed through the optical device. Operation S25 of calculating the uniformity may include first size value calculating operation S251 of calculating a first size value, second size value calculating operation S252 of calculating a second size value, and deviation calculating operation S253 of calculating a deviation of each of the first size value and the second size value.

Determination operation S26 may be an operation of determining whether the first-1 value and the first-2 value are appropriate, based on the uniformity extracted by a uniformity calculation unit. Determination operation S26 may be an operation of determining that the first-1 value and the first-2 value are appropriate such that the deviation of each of the first size value and the second size value is between 0 and a specified value.

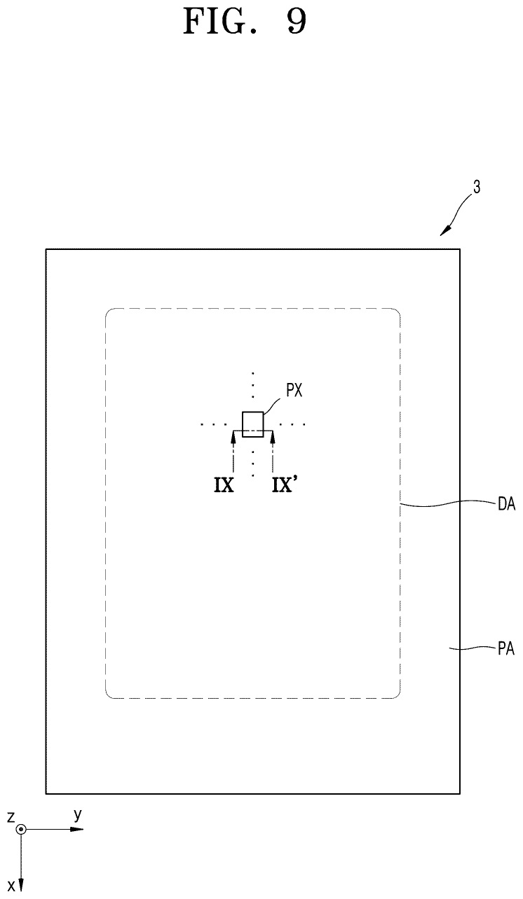

FIG. 9 is a schematic plan view of a display device 3 according to an embodiment.

Referring to FIG. 9, the display device 3 manufactured according to an embodiment may include a display area DA and a peripheral area PA adjacent to the display area DA. The display device 3 may provide an image through an array of multiple pixels PX, which are two-dimensionally arranged in the display area DA.

The peripheral area PA may be an area which does not provide an image, and may entirely or partially surround the display area DA in a plan view. A driver configured to provide electrical signals or power to a pixel circuit corresponding to each of the pixels PX or the like may be arranged in the peripheral area PA. A pad, which is an area to which an electronic device or a printed circuit board may be electrically connected, may be arranged in the peripheral area PA.

Hereinafter, although the display device 3 is described as including an organic light-emitting diode (OLED) as a light-emitting element, the display device 3 is not limited thereto. In another embodiment, the display device 3 may be a light-emitting display device including an inorganic light-emitting diode, for example, an inorganic light-emitting display device. The inorganic light-emitting diode may include a PN junction diode including materials based on inorganic semiconductors. In case that a voltage is applied to the PN junction diode in a forward direction, holes and electrons may be injected, and energy generated by recombination of the holes and electrons may be converted into light energy to emit a certain color of light. The inorganic light-emitting diode described above may have a width of several micrometers to several hundreds of micrometers, and in embodiments, the inorganic light-emitting diode may be referred to as a micro light-emitting diode (LED). In another embodiment, the display device 3 may be a quantum dot light-emitting display device.

The display device 3 may be a portable electronic device, such as a mobile phone, a smartphone, a table personal computer (PC), a mobile communication terminal, an electronic notebook, an electronic book, a portable multimedia player (PMP), a navigation device, an Ultra Mobile PC (UMPC), or the like, or may be used as a display screen of various products, such as a television, a laptop computer, a monitor, an advertisement board, an Internet of things (IoT) device, or the like. The display device 3 according to an embodiment may be used as a wearable device, such as a smart watch, a watch phone, a glasses-type display, and a head-mounted display (HMD). The display device 3 according to an embodiment may be applied to a dashboard of a vehicle, a center fascia of a vehicle, a center information display (CID) disposed on a dashboard, a rear-view mirror display replacing a side mirror of a vehicle, and a display screen disposed on a back surface of a front seat as entertainment for a passenger in a back seat of a vehicle.

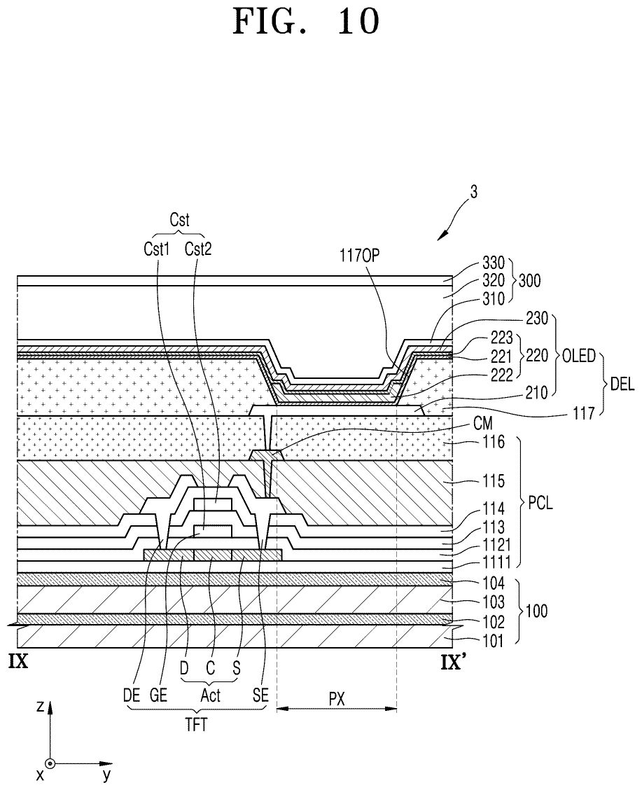

FIG. 10 is a schematic cross-sectional view of the display device 3 according to an embodiment, taken along line IX-IX′ of FIG. 9.

Referring to FIG. 10, the display device 3 may include a stacked structure of a substrate 100, a pixel circuit layer PCL, a display element layer DEL, and an encapsulation layer 300.

The substrate 100 may have a multi-layered structure including a base layer and an inorganic layer, the base layer including a polymer resin. For example, the substrate 100 may include a base layer including the polymer resin, and a barrier layer of an inorganic insulating layer. For example, the substrate 100 may include a first base layer 101, a first barrier layer 102, a second base layer 103, and a second barrier layer 104, which are sequentially stacked. Each of the first base layer 101 and the second base layer 103 may include polyimide (PI), polyethersulfone (PES), polyarylate, polyetherimide (PEI), polyethylene naphthalate (PEN), polyethylene terephthalate (PET), polyphenylene sulfide (PPS), polycarbonate, cellulose triacetate (TAC), cellulose acetate propionate (CAP), or the like. The first barrier layer 102 and the second barrier layer 104 may each include an inorganic insulating material, such as silicon oxide, silicon nitride, and/or silicon oxynitride. The substrate 100 may be flexible.

The pixel circuit layer PCL may be disposed on the substrate 100. In an embodiment, the pixel circuit layer PCL may include a thin-film transistor TFT, a buffer layer 1111, a first gate insulating layer 1121, a second gate insulating layer 113, an interlayer insulating layer 114, a first planarization insulating layer 115, and a second planarization insulating layer 116, wherein the buffer layer 1111, the first gate insulating layer 1121, the second gate insulating layer 113, the interlayer insulating layer 114, the first planarization insulating layer 115, and the second planarization insulating layer 116 may be disposed below or/and above components of the thin-film transistor TFT.

The buffer layer 1111 may reduce or block penetration of foreign materials, moisture, or external air from a lower portion of the substrate 100 and may provide a flat surface on the substrate 100. The buffer layer 1111 may include an inorganic insulating material, such as silicon oxide, silicon oxynitride, and silicon nitride, and may include a single layered structure or a multi-layered structure, each including the above-stated material.

The thin-film transistor TFT disposed on the buffer layer 1111 may include a semiconductor layer Act, and the semiconductor layer Act may include polysilicon (poly-Si). In another embodiment, the semiconductor layer Act may include amorphous silicon (a-Si), an oxide semiconductor, an organic semiconductor, or the like. The semiconductor layer Act may include a channel area C, a drain area D, and a source area S, and the drain area D and the source area S may be respectively arranged on sides of the channel area C. A gate electrode GE of the thin-film transistor TFT may overlap the channel area C in a plan view.

The gate electrode GE may include a low-resistance metal material. The gate electrode GE may include a conductive material including molybdenum (Mo), aluminum (AI), copper (Cu), titanium (Ti), or the like, and may be a multi-layer or a single layer, each including the material stated above.

The first gate insulating layer 1121 between the semiconductor layer Act and the gate electrode GE may include an inorganic insulating material, such as silicon oxide (SiO₂), silicon nitride (SiN_{X}), silicon oxynitride (SiON), aluminum oxide (Al₂O₃), titanium oxide (TiO₂), tantalum oxide (Ta₂O₅), hafnium oxide (HfO₂), zinc oxide (ZnOₓ), or the like. The zinc oxide (ZnO_{X}) may be zinc oxide (ZnO) and/or zinc peroxide (ZnO₂).

The second gate insulating layer 113 may cover the gate electrode GE. Similar to the first gate insulating layer 1121, the second gate insulating layer 113 may include an inorganic insulating material, such as silicon oxide (SiO₂), silicon nitride (SiNₓ), silicon oxynitride (SiON), aluminum oxide (Al₂O₃), titanium oxide (TiO₂), tantalum oxide (Ta₂O₅), hafnium oxide (HfO₂), zinc oxide (ZnOₓ), or the like. The zinc oxide (ZnO_{X}) may be zinc oxide (ZnO) and/or zinc peroxide (ZnO₂).

An upper electrode Cst2 of a storage capacitor Cst may be disposed on the second gate insulating layer 113. The upper electrode Cst2 may overlap the gate electrode GE in a plan view. The gate electrode GE and the upper electrode Cst2, which overlap each other with the second gate insulating layer 113 between the gate electrode GE and the upper electrode Cst2, and may form the storage capacitor Cst. For example, the gate electrode GE may function as a lower electrode Cst1 of the storage capacitor Cst.

As such, the storage capacitor Cst and the thin-film transistor TFT may overlap each other in a plan view. In embodiments, the storage capacitor Cst may not overlap the thin-film transistor TFT.

The upper electrode Cst2 may include Al, platinum (Pt), palladium (Pd), silver (Ag), magnesium (Mg), gold (Au), nickel (Ni), neodymium (Nd), iridium (Ir), chromium (Cr), calcium (Ca), Mo, Ti, tungsten (W), and/or Cu, and may be a single layer or a multi-layer, each including the material stated above.

The interlayer insulating layer 114 may cover the upper electrode Cst2. The interlayer insulating layer 114 may include an inorganic insulating material, such as silicon oxide (SiO₂), silicon nitride (SiNₓ), silicon oxynitride (SiON), aluminum oxide (Al₂O₃), titanium oxide (TiO₂), tantalum oxide (Ta₂O₅), hafnium oxide (HfO₂), zinc oxide (ZnOₓ), or the like. The zinc oxide (ZnO_{X}) may be zinc oxide (ZnO) and/or zinc peroxide (ZnO₂). The interlayer insulating layer 114 may include a single layer or a multi-layer, each including the inorganic insulating material stated above.

Each of a drain electrode DE and a source electrode SE of the thin-film transistor TFT may be disposed on the interlayer insulating layer 114. The drain electrode DE and the source electrode SE may respectively be connected to the drain area D and the source area S through contact holes formed in insulating layers below the drain electrode DE and the source electrode SE. The drain electrode DE and the source electrode SE may each include a material having good conductivity. The drain electrode DE and the source electrode SE may each include a conductive material including Mo, Al, Cu, Ti, or the like, and may include a multi-layer or a single layer, each including the above material. In an embodiment, the drain electrode DE and the source electrode SE may each have a multi-layered structure of Ti/Al/Ti.

The first planarization insulating layer 115 may cover the drain electrode DE and the source electrode SE. The first planarization insulating layer 115 may include a general commercial polymer, such as poly(methyl methacrylate) (PMMA) or polystyrene (PS), and a polymer derivative having a phenol group, and an organic insulating material, such as an acrylic polymer, an imide polymer, an aryl ether polymer, an amide polymer, a fluorine polymer, a p-xylene polymer, a vinyl alcohol polymer, and a mixture thereof.

The second planarization insulating layer 116 may be disposed on the first planarization insulating layer 115. The second planarization insulating layer 116 and the first planarization insulating layer 115 may include a same material. For example, the second planarization insulating layer 116 may include a general commercial polymer, such as PMMA or PS, a polymer derivative having a phenol group, and an organic insulating material, such as an acrylic polymer, an imide polymer, an aryl ether polymer, an amide polymer, a fluorine polymer, a p-xylene polymer, a vinyl alcohol polymer, and a mixture thereof.

The display element layer DEL may be disposed on the pixel circuit layer PCL having the structure described above. The display element layer DEL may include an organic light-emitting diode OLED as a display element (for example, a light-emitting element), and the organic light-emitting diode OLED may include a stacked structure of a pixel electrode 210, an intermediate layer 220, and a common electrode 230. The organic light-emitting diode OLED may emit, for example, red, green, or blue light, or may emit red, green, blue, or white light. The organic light-emitting diode OLED may emit light through an emission area, and define the emission area as a pixel PX.

The pixel electrode 210 of the organic light-emitting diode OLED may be electrically connected to the thin-film transistor TFT through contact holes formed in the second planarization insulating layer 116 and the first planarization insulating layer 115 and a contact metal CM disposed on the first planarization insulating layer 115.

The pixel electrode 210 may include a conductive oxide, such as indium tin oxide (ITO), indium zinc oxide (IZO), zinc oxide (ZnO), indium oxide (In₂O₃), indium gallium oxide (IGO), or aluminum zinc oxide (AZO). In another embodiment, the pixel electrode 210 may include a reflective film including Ag, Mg, Al, Pt, Pd, Au, Ni, Nd, Ir, Cr, or a compound thereof. In another embodiment, the pixel electrode 210 may further include a film including ITO, IZO, ZnO, or In₂O₃ above/below the reflective film described above.

A bank layer 117 having an opening 117OP exposing a central portion of the pixel electrode 210 may be disposed on the pixel electrode 210. The bank layer 117 may include an organic insulating material and/or an inorganic insulating material. The opening 117OP may define an emission area of light emitted from the organic light-emitting diode OLED. For example, the size/width of the opening 117OP may correspond to the size/width of the emission area. Accordingly, the size and/or width of the pixel PX may depend on the size and/or width of the opening 117OP of the bank layer 117.

The intermediate layer 220 may include an emission layer 222 formed to correspond to the pixel electrode 210. The emission layer 222 may include a polymer organic material or a low-molecular-weight organic material, which emits light of a certain color. In another embodiment, the emission layer 222 may include an inorganic light-emitting material or a quantum dot.

In an embodiment, the intermediate layer 220 may include a first functional layer 221 and a second functional layer 223 respectively disposed below and on the emission layer 222. The first functional layer 221 may include a hole transport layer (HTL), or an HTL and a hole injection layer (HIL). The second functional layer 223 may be a component disposed on the emission layer 222, and may include an electron transport layer ETL and/or an electron injection layer (EIL). Similar to the common electrode 230 described below, the first functional layer 221 and/or the second functional layer 223 may be a common layer entirely covering the substrate 100.

The common electrode 230 may be disposed above the pixel electrode 210 and overlap the pixel electrode 210 in a plan view. The common electrode 230 may include a conductive material having a low work function. For example, the common electrode 230 may include a (semi) transparent layer including Ag, Mg, Al, Pt, Pd, Au, Ni, Nd, Ir, Cr, lithium (Li), Ca, the like, or an alloy thereof. In an embodiment, the common electrode 230 may further include a layer including ITO, IZO, ZnO, or In₂O₃, above the (semi) transparent layer including the materials stated above. The common electrode 230 may be integrally formed to entirely cover the substrate 100.

The encapsulation layer 300 may be disposed on the display element layer DEL and cover the display element layer DEL. The encapsulation layer 300 may include at least one inorganic encapsulation layer and at least one organic encapsulation layer, and as shown in an embodiment of FIG. 10, the encapsulation layer 300 may include a first inorganic encapsulation layer 310, an organic encapsulation layer 320, and a second inorganic encapsulation layer 330, which are sequentially stacked.

The first inorganic encapsulation layer 310 and the second inorganic encapsulation layer 330 may each include at least one inorganic material of aluminum oxide, titanium oxide, tantalum oxide, hafnium oxide, zinc oxide, silicon oxide, silicon nitride, and silicon oxynitride. The organic encapsulation layer 320 may include a polymer-based material. The polymer-based material may include an acrylic resin, an epoxy resin, polyimide, polyethylene, or the like. In an embodiment, the organic encapsulation layer 320 may include acrylate. The organic encapsulation layer 320 may be formed by curing a monomer or coating a polymer. The organic encapsulation layer 320 may have transparency.

Although not shown in FIG. 10, a touch sensor layer may be disposed on the encapsulation layer 300, and an optical functional layer may be disposed on the touch sensor layer. The touch sensor layer may obtain coordinate information according to an external input, for example, a touch event. The optical functional layer may reduce the reflectance of light (external light) incident from the outside toward the display device, and/or improve color purity of light emitted by the display device. In an embodiment, the optical functional layer may include a retarder and/or a polarizer. The retarder may be a film type or a liquid-crystal coating type, and may include a λ/2 retarder and/or a λ/4 retarder. The polarizer may also be a film type or a liquid-crystal coating type. The film-type polarizer may include a stretch-type synthetic resin film, and the liquid-crystal-coating-type polarizer may include liquid crystals in a certain arrangement. The retarder and the polarizer may further include a protective film.

An adhesive member may be arranged between the touch sensor layer and the optical functional layer. As the adhesive member, a general adhesive member may be employed without limitation. The adhesive member may be a pressure sensitive adhesive (PSA).

The display substrate DS described above with reference to FIGS. 1 to 8 may include at least one of the substrate 100, the pixel circuit layer PCL, the display element layer DEL, and the encapsulation layer 300.

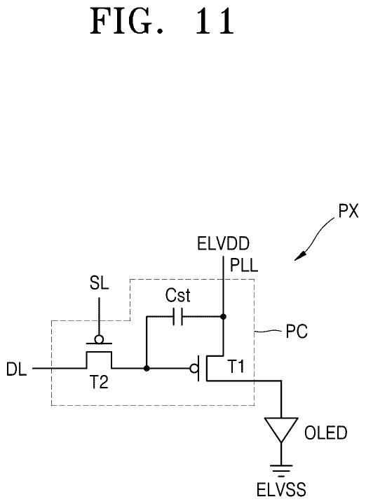

FIG. 11 is a schematic diagram of an equivalent circuit of a pixel of a display panel according to an embodiment.

Each pixel PC may include a pixel circuit PC and a display element connected to the pixel circuit PC, for example, an organic light-emitting diode OLED. The pixel circuit PC may include a first thin-film transistor T1, a second thin-film transistor T2, and a storage capacitor Cst. Each pixel PX may emit, for example, red, green, blue, or white light through the organic light-emitting diode OLED.

The second thin-film transistor T2 may be a switching thin-film transistor, which may be connected to a scan line SL and s data line DL and be configured to transfer, to the first thin-film transistor T1, a data voltage input from the data line DL based on a switching voltage input from the scan line SL. The storage capacitor Cst may be connected to the second thin-film transistor T2 and a driving voltage line PLL and store a voltage corresponding to a difference between a voltage received from the second thin-film transistor T2 and a first power supply voltage ELVDD supplied to the driving voltage line PLL.

The first thin-film transistor T1 may be a driving thin-film transistor, which may be connected to the driving voltage line PLL and the storage capacitor Cst and control a driving current flowing from the driving voltage line PLL through the organic light-emitting diode OLED, in accordance with a voltage value stored in the storage capacitor Cst. The organic light-emitting diode OLED may emit light having a brightness according to the driving current. An opposite electrode (e.g., a cathode) of the organic light-emitting diode OLED may receive a second power supply voltage ELVSS.

FIG. 11 shows that the pixel circuit PC includes two thin-film transistors and one storage capacitor, but the disclosure is not limited thereto. The number of thin-film transistors and the number of storage capacitors may be variously changed according to the design of the pixel circuit PC. For example, the pixel circuit PC may include four or more thin-film transistors in addition to the above-mentioned two thin-film transistors.

According to embodiments, time and cost may be reduced in setting various design values required to manufacture an optical device.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An apparatus for manufacturing an optical device comprising a barrel portion and a first lens arranged in the barrel portion, the apparatus comprising:
a light simulation part that receives initial design values for the optical device and simulate light passing through the optical device; and
a Monte Carlo simulation part that determines whether the initial design values are appropriate by using Monte Carlo simulation.

2. The apparatus of claim 1, wherein
the light simulation part comprises:
an initial value input part that receives a first-first value, which is an initial standard dimension, and a first-second value, which is an initial tolerance value, for each of a plurality of first variables that are design variables of the optical device; and
an ideal light value extraction part that extracts an ideal second-first value of a second variable for light passing through the optical device, that is expected to be obtained when manufacturing the optical device with the first-first value and the first-second value for each of the plurality of first variables, and the Monte Carlo simulation part comprises:
a random value extraction part that randomly extracts a first-31 value and a first-32 value for each of the plurality of first variables, each of the first-31 value and the first-32 value having an absolute value that is less than an absolute value of the first-second value;
a first case extraction part that extracts, for each of the plurality of first variables, a second-21 value of the second variable, which is expected to be obtained when manufacturing the optical device in a first case where a standard dimension is the first-first value, and a design error is the first-31 value;
a second case extraction part that extracts, for each of the plurality of first variables, a second-22 value of the second variable, which is expected to be obtained when manufacturing the optical device in a second case where the standard dimension is the first-first value, and the design error is the first-32 value;
a case selection part that selects one of the first case and the second case by determining a value closer to the ideal second-first value from among the second-21 value and the second-22 value;
a spot size extraction part that extracts a spot size of light that has passed through the optical device for the one of the first case and the second case selected by the case selection part;
a uniformity calculation part that calculates a uniformity of spot sizes of light that has passed through the optical device; and
a determination part that determines whether the first-first value and the first-second value are appropriate based on the uniformity calculated by the uniformity calculation part.

3. The apparatus of claim 2, wherein
the spot size extraction part extracts the spot size of light that has passed through the optical device in a first direction and the spot size of light that has passed through the optical device in a second direction intersecting the first direction, and
the uniformity calculation part comprises:
a first value calculation part that calculates a first size value that is a greater value of a maximum value of the spot size in the first direction and a maximum value of the spot size in the second direction;
a second size calculation part that calculates a second size value that is a smaller value of a minimum value of the spot size in the first direction and a minimum value of the spot size in the second direction; and
a deviation calculation part that calculates a deviation of each of the first size value and the second size value.

4. The apparatus of claim 3, wherein the determination part further determines that the first-first value and the first-second value are appropriate in case that the deviation is in a range of 0 to a specified value.

5. The apparatus of claim 2, wherein the plurality of first variables comprise at least one of a curvature of the first lens, a central thickness of the first lens, and a diameter of the first lens.

6. The apparatus of claim 2, wherein the plurality of first variables comprise at least one of an angle at which the first lens is tilted from the barrel portion, a distance from a central axis of the barrel portion to a center of the first lens, a distance from an opening portion of the barrel portion to the first lens, and a diameter of the opening portion of the barrel portion.

7. The apparatus of claim 2, wherein the second variable comprises a spot root-mean-square (RMS) radius.

8. The apparatus of claim 2, wherein the second variable comprises a root-mean-square (RMS) wavefront aberration value.

9. A method of manufacturing an optical device comprising a barrel portion and a first lens arranged in the barrel portion, the method comprising:
a light simulation operation of receiving initial design values for the optical device and simulating light passing through the optical device; and
a Monte Carlo simulation operation of determining whether the initial design values are appropriate by using Monte Carlo simulation.

10. The method of claim 9, wherein
the light simulation operation comprises:
an initial value inputting operation of receiving a first-first value, which is an initial standard dimension, and a first-second value, which is an initial tolerance value, for each of a plurality of first variables that are design variables of the optical device; and
an ideal light value extracting operation of extracting an ideal second-first value of a second variable for light passing through the optical device, that is expected to be obtained when manufacturing the optical device with the first-first value and the first-second value for each of the plurality of first variables, and
Monte Carlo simulation operation comprises:
a random value extracting operation of randomly extracting a first-31 value and a first-32 value for each of the plurality of first variables, each of the first-31 value and the first-32 value having an absolute value that is less than an absolute value of the first-second value;
a first case extracting operation of extracting, for each of the plurality of first variables, a second-21 value of the second variable, which is expected to be obtained when manufacturing the optical device in a first case where a standard dimension is the first-first value, and a design error is the first-31 value;
a second case extracting operation of extracting, for each of the plurality of first variables, a second-22 value of the second variable, which is expected to be obtained when manufacturing the optical device in a second case where the standard dimension is the first-first value, and the design error is the first-32 value;
a case selecting operation of selecting one of the first case and the second case by determining a value closer to the ideal second-first value from among the second-21 value and the second-22 value;
a spot size extracting operation of extracting a spot size of light that has passed through the optical device for the one of the first case and the second case selected in the case selecting operation;
a uniformity calculating operation of calculating a uniformity of spot sizes of light that has passed through the optical device; and
a determination operation of determining whether the first-first value and the first-second value are appropriate based on the uniformity calculated in the uniformity calculating operation.

11. The method of claim 10, wherein the
spot size extracting operation comprises extracting the spot size of light that has passed through the optical device in a first direction and the spot size of light that has passed through the optical device in a second direction intersecting the first direction, and
the uniformity calculating operation comprises:
a first size value calculating operation of calculating a first size value that is a greater value of a maximum value of the spot size in the first direction and a maximum value of the spot size in the second direction;
a second size value calculating operation of calculating a second size value that is a smaller value of a minimum value of the spot size in the first direction and a minimum value of the spot size in the second direction; and
a deviation calculating operation of calculating a deviation of each of the first size value and the second size value.

12. The method of claim 11, wherein the determination operation comprises determining that the first-first value and the first-second value are appropriate in case that the deviation is in a range of 0 to a specified value.

13. The method of claim 10, wherein the plurality of first variables comprise at least one of a curvature of the first lens, a central thickness of the first lens, and a diameter of the first lens.

14. The method of claim 10, wherein the plurality of first variables comprise at least one of an angle at which the first lens is tilted from the barrel portion, a distance from a central axis of the barrel portion to a center of the first lens, a distance from an opening portion of the barrel portion to the first lens, and a diameter of the opening portion of the barrel portion.

15. The method of claim 10, wherein the second variable comprises a spot root-mean-square (RMS) radius.

16. The method of claim 10, wherein the second variable comprises a root-mean-square (RMS) wavefront aberration value.
